(19) United States
(12) Patent Application Publication
(10) Pub. No.: US 2020/0396961 A1
(43) Pub. Date: Dec. 24, 2020

(54) CONTAINER FOR AN AQUEOUS COMPOSITION

(71) Applicant: SUSU PETS, LLC, Grand Blanc, MI (US)

(72) Inventor: Summer Zetouna, Grand Blanc, MI (US)

(21) Appl. No.: 16/905,135

(22) Filed: Jun. 18, 2020

Related U.S. Application Data
(60) Provisional application No. 62/862,960, filed on Jun. 18, 2019.

(51) Int. Cl. A01K 7/00; A23K 20/174; A23K 20/26; A23K 20/24; A23K 20/22; A23K 20/20; A23K 10/30; A23K 20/142; A23K 20/158; A23K 20/189; A23K 10/18; A23K 20/179

(52) U.S. Cl. CPC A01K 7/005; A23K 20/174; A23K 20/26; A23K 20/24; A23K 20/22; A23K 20/179; A23K 10/30; A23K 20/142; A23K 20/158; A23K 20/189; A23K 10/18; A23K 20/30

(57) ABSTRACT

A container for storing an aqueous composition for a domestic animal is provided herein. The container includes a shell having base and a wall extending distally from the base to a lip. The shell defines a chamber between the base and the lip. The container further includes a lid. The lid is configured to cooperate with the lip for removably coupling the lid and the shell. The container further includes an aqueous composition disposed within the chamber. The shell and the lid exhibit a water vapor transmission rate of less than 100,000 g/m^{2/24} hours in accordance with ASTM D6701-16.

### CROSS-REFERENCE TO RELATED APPLICATIONS

This application claims priority to and all of advantages of U.S. Prov. Appl. No. 62/862,960, filed on 18 Jun. 2019, the contents of which is hereby incorporated by reference.

### TECHNICAL FIELD

The present disclosure generally relates a container for an aqueous composition. The present disclosure also relates to methods of forming the container, methods of utilizing the container, and uses of the container.

### BACKGROUND

Pet bowls are typically placed on the floor in proximity of stored bulk pet food and a water source. Traditionally a pet bowl, especially a water bowl, never leaves its location in the household, a kennel or another setting. It is common that even though a food bowl may be taken from a domestic animal, a water bowl is left out all day in the same location, as water is vital to an animal's health.

The utility of a water bowl is limited however by its nearness to a water source because it generally does not have an ability to retain liquid without spilling while being transported. Typically 4 oz. or 8 oz. of water is placed in a conventional pet bowl, that is, one that has a shallow concave bowl approximately 2″ deep with a 4.5″ aperture for an animal to drink from, spills easily. The relation between the volume of water stored in a bowl, the shallow walls of the bowl, and movement of the water while the bowl is in transport creates a wave that will inevitably overcome the rim of the bowl.

This limitation comes at a disadvantage because the trend for domestic animals accompanying their owners or guardians while traveling is increasing. Domestic animals are more visible joining their owners at work, hotel stays, flying, road trips, shopping, outdoor dining, and indoor and or outdoor events. Further, domestic animals are increasingly used by police and military forces in environments where potable water may not be available. Bringing food and water, especially water, along on these outings insures the health and safety of the domestic animals.

For many owners, bringing along their domestic animal's daily water bowl poses the aforementioned limitations. Therefore, many owners resort to impromptu methods of providing water to their domestic animals during travel. Human plastic food containers with sealable lids, or recycle other human containers previously meant to hold solid products such as margarine, cottage cheese and other foods relying on shallow containers with roughly 4.5″ apertures, may be utilized. Some lids, but not all, used with these containers are not watertight and the friction required to open the lid pops-open causing a splashing effect; spilling and wasting water when opened. Another drawback to these methods is that some animals are finicky and may not drink from a bowl that it is not their own.

If no container is available to transport water, owners have to buy previously filled water bottles and then search for a receptacle large enough for a domestic animal's to consume from. In situations where there is no container, the owner has no option but to pour the water straight from the bottle's neck with the hopes that the domestic animal can get the water it needs. This results in wasting water, and is ineffectual when indoors, especially inside a car. Another solution is cupping ones hand for use as a dish. This is unsanitary, not convenient, and does hold water for any meaningful length of time.

Moreover, many of the aforementioned conventional options for providing water rely on containers or bowls that must either be (1) kept, cleaned, and re-used or (2) disposed of which will likely result as a long-term accumulation of plastic in bodies of water or landfills. While re-use of conventional containers or bowls can minimize long-term accumulation of plastic in bodies of water or landfills, it may not be convenient to carry and clean the used conventional container or bowl (e.g. travel or police and military operations).

Accordingly, it is desirable to provide an improved container and methods relating to the same Furthermore, other desirable features and characteristics will become apparent from the subsequent summary and detailed description and the appended claims, taken in conjunction with the foregoing technical field and background.

### BRIEF SUMMARY

A container for storing an aqueous composition for a domestic animal is provided herein. The container includes a shell having base and a wall extending distally from the base to a lip. The shell defines a chamber between the base and the lip. The container further includes a lid. The lid is configured to cooperate with the lip for removably coupling the lid and the shell. The container further includes an aqueous composition disposed within the chamber. The shell and the lid exhibit a water vapor transmission rate of less than 100,000 g/m²/24 hours in accordance with ASTM D6701-16.

### BRIEF DESCRIPTION OF THE DRAWING(S)

The present invention will hereinafter be described in conjunction with the following drawing figures, wherein like numerals denote like elements, and

FIG. 1 is a perspective view illustrating a non-limiting embodiment of a lid of a container for a domestic animal;

FIG. 2 is another perspective view illustrating a non-limiting embodiment of the lid of FIG. 1;

FIG. 3 is a side view illustrating a non-limiting embodiment of the lid of FIG. 1;

FIG. 4 is a cross-sectional side view illustrating a non-limiting embodiment of the lid of FIG. 1;

FIG. 5 is another cross-sectional side view illustrating a non-limiting embodiment of the lid of FIG. 1;

FIG. 6 is a perspective view illustrating a non-limiting embodiment of a shell of a container for a domestic animal;

FIG. 7 is side view illustrating a non-limiting embodiment of the shell of FIG. 6;

FIG. 8 is top view illustrating a non-limiting embodiment of the shell of FIG. 6; and

FIG. 9 is a cross-sectional side view illustrating a non-limiting embodiment of the shell of FIG. 6.

### DETAILED DESCRIPTION

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

The following detailed description is merely exemplary in nature and is not intended to limit the invention or the application and uses of the invention. Furthermore, there is no intention to be bound by any theory presented in the preceding background or the following detailed description.

A container for storing an aqueous composition for a domestic animal, a method of forming the container, a method of utilizing the container, and a use of the container, are disclosed herein. The container is described immediately below, followed by a description of the method of forming the container, the method of utilizing the container, and the use of the container. However, the container of the present invention is not limited to a particular method of forming, method of utilizing, or use.

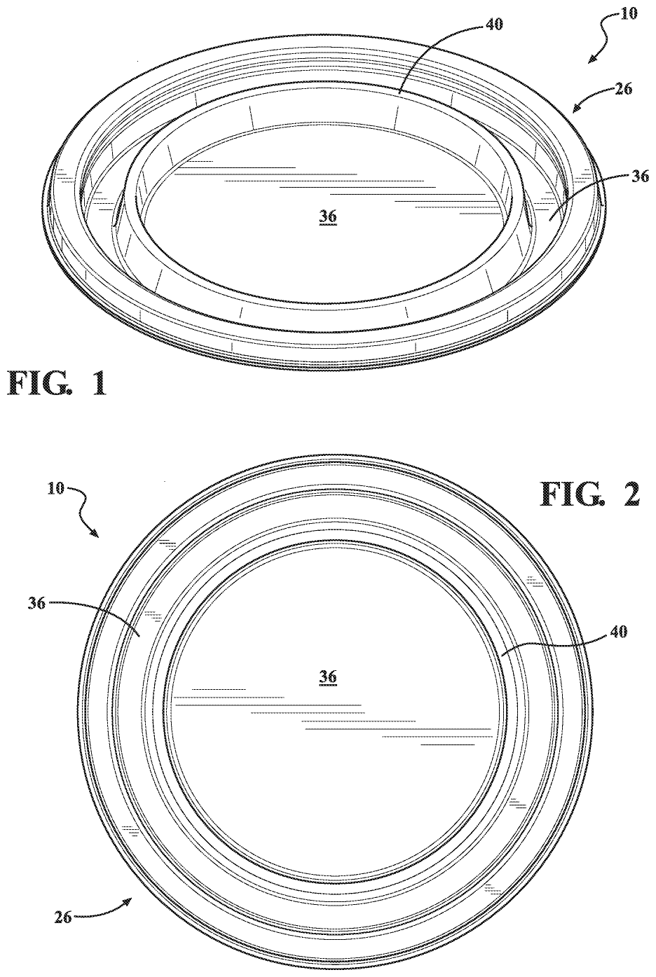

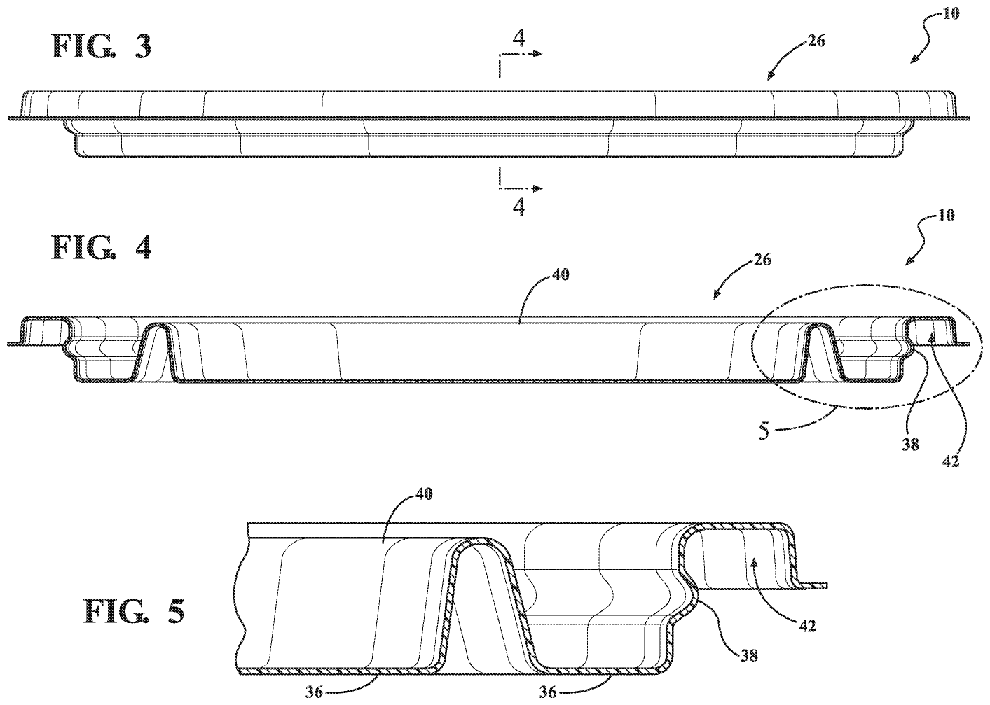

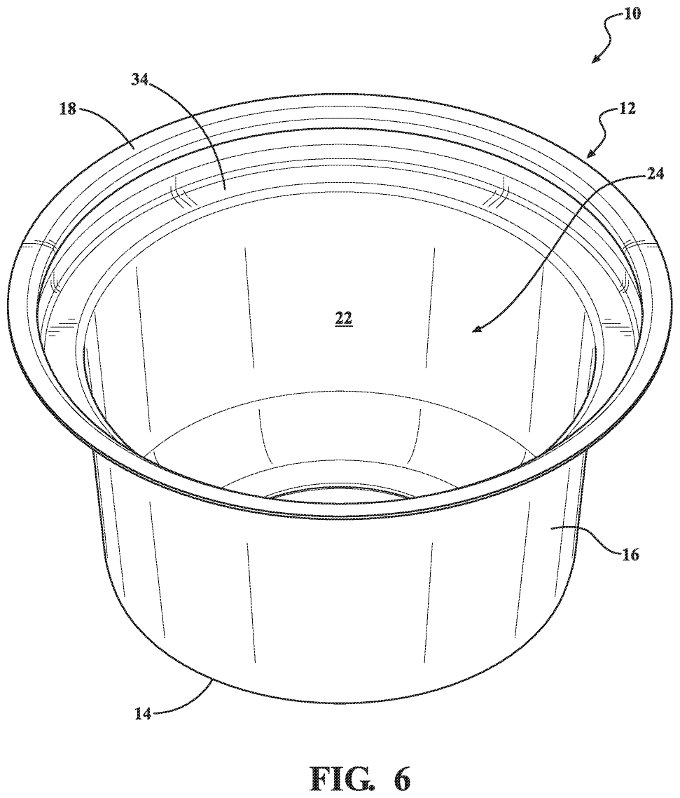

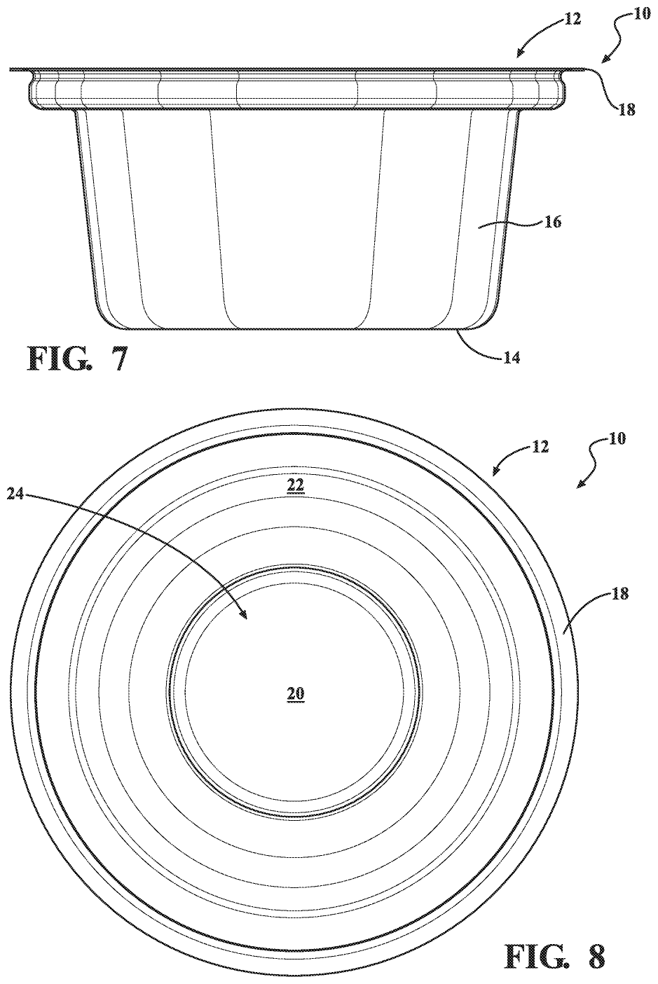

FIGS. 1-9 illustrate a non-limiting embodiment of the container 10 for a domestic animal. The container 10 includes an aqueous composition and may be suitable for storing and providing the aqueous composition to a variety of domestic animals, or pets, such as cats, dogs, and livestock. The container 10 may be adapted to prevent unintentional release of the aqueous composition outside of the container 10. Further, the container 10 may be adapted to prevent contamination or tampering of the aqueous composition disposed therein. The container 10 is generally shaped and sized to enable a domestic animal, such as a dog or cat, to consume the aqueous composition from the container 10. Additionally, the container 10 may be adapted to minimize exposure of a variety of elements that have a potential to cause harm to the domestic animal, such as sharp edges that may lacerate the domestic animal. In certain embodiments, the container 10 is intended for single-use such that the container may not be intended to be re-filled, washed, or otherwise re-used following consumption of the aqueous composition.

In various embodiments, the container 10 may be provided to a domestic animal that is malnourished or nutritionally deficient due to disease, environmental contamination, age, or combinations thereof. As will be described below, the container 10 has been configured to be stabilized to allow for a domestic animal to feed from the container 10 without flipping over the container 10. This may be suitable for both healthy and nutritionally deficient domestic animals.

With continued reference to FIGS. 1-9, the container 10 includes a shell 12. The shell 12 may have a frustoconical configuration. However, it is to be appreciated that the shell 12 may have any configuration known in the art that is suitable for providing an aqueous composition to domestic animals. The shell 12 may include a biodegradable material. The term “biodegradable,” as utilized herein, means a material that substantially completely decomposes over a period of less than 10 years, alternatively less than 5 years, or alternatively less than 3 year, to primarily carbon dioxide, water, or biomass, in the presence of a favorable environment for decomposition. Non-limiting examples of suitable biodegradable materials are known in the art, including polyanhydrides and aliphatic polyesters, such as polylactic acid, polyglycolic acid, polycarbonates, polyfumarates caprolactone, cellulose acetates, and combinations thereof.

In certain embodiments, the biodegradable material of the shell 12 includes a polymeric material, a lignocellulosic material, or a combination thereof. In one exemplary embodiments, the biodegradable material of the shell 12 includes the polymeric material and the polymeric material may formed from polylactic acid. In another exemplary embodiment, the biodegradable material of the shell 12 includes the lignocellulosic material and the lignocellulosic material may formed from wheat straw, bamboo, husks, sugar cane, bulrush, or combinations thereof.

The shell 12 is adapted to store the aqueous composition therein for a prolonged period of time. The shell 12 exhibits a water vapor transmission rate of less than 100,000, alternatively less than 50,000, or alternatively less than 10,000, alternatively less than 1,000, alternatively less than 100, or alternatively less than 10, g/m²/24 hours, in accordance with ASTM D6701-16.

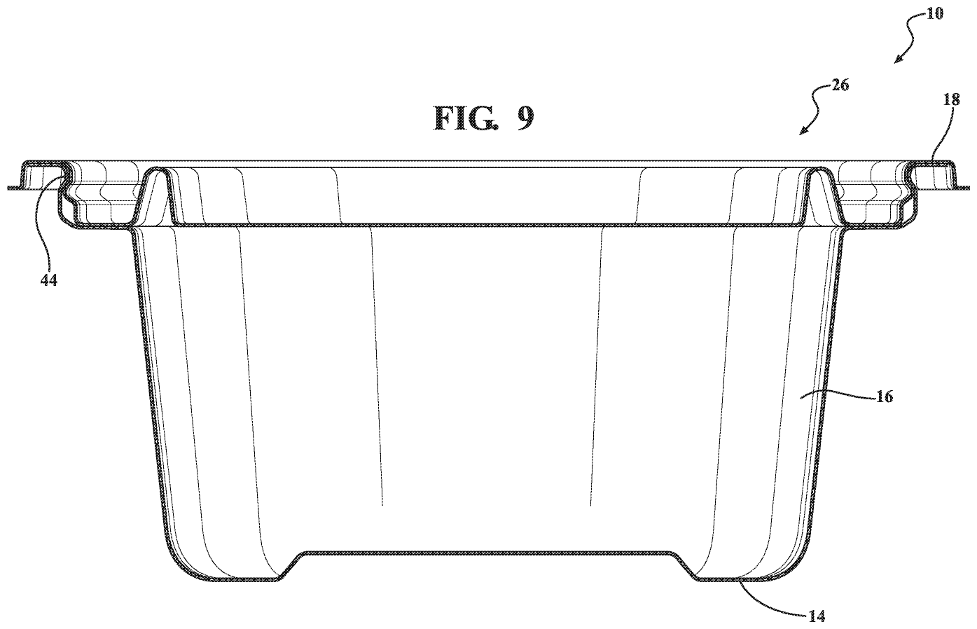

With continued reference to FIGS. 1-9, the shell 12 has a base 14 and a wall 16 extending distally from the base 14 to a lip 18. A shelf 34 may extend laterally relative to the base 14 between the base 14 and the lip 18. The lip 18 may define a shell flange 44 extending parallel to the shelf 34 (see FIG. 9). The base 14 may have an interior base surface 20 and an interior wall surface 22. The interior base surface 20 and the interior wall surface 22 may be adapted to minimize exposure of a variety of elements that have a potential to cause harm to the domestic animal, such as sharp edges that may lacerate the domestic animal. The base 14, the wall 16, and the lip 18 may be integrally formed as a single, unitary, one-piece assembly.

The shell 12 defines a chamber 24 between the base 14 and the lip 18. The chamber 24 may have a depth from the lip 18 to the base 14 in an amount of from 0.001 to 10 meters, alternatively from 0.01 to 1 meters, or alternatively from 0.01 to 0.2 meters. The chamber 24 may have a diameter extending from a first point of the lip 18 to a second point of the lip 18 opposite the first point of the lip 18 in an amount of from 0.001 to 10 meters, alternatively from 0.01 to 1 meters, or alternatively from 0.01 to 0.5 meters.

The container 10 further includes a lid 26 configured to cooperate with the lip 18 for removably coupling the lid 26 and the shell 12. The lid 26 may be formed of a biodegradable material, such as the biodegradable material described above for the shell 12. The lid 26 and the shell 12 are adapted to cooperate to prevent unintentional release of the aqueous composition outside of the container 10. In some embodiments, the lid 26 deforms about lip 18 to bias the lid 26 against the lip 18 to prevent unintentional release of the aqueous composition outside of the container 10. The lid 26 has a surface 36 extending along the lid 26. In various embodiments, the lid 26 includes a lid flange 38 extending parallel to the surface 36 (see FIG. 4). The lid flange 38 may cooperate with the lip 18 to prevent unintentional release of the aqueous composition outside of the container 10. The lid 26 may define a slot 42 adjacent the lid flange 38 (see FIG. 4). The slot 42 is configured to receive the lip 26 such that the lid flange 38 can engage the shell flange 44 of the lip 26. In various embodiments, this cooperation between the shell flange 44 and the lid flange 38 provides a suitable seal between the shell 12 and the lid 26 to prevent release of the aqueous composition out the chamber 24 into the environment. This can provide reusability of the aqueous composition in the container 10.

The lid 26 includes an extension 40 extending laterally relative to the surface 36. The extension 40 is configured to receive the base 14 for stabilizing the shell 12 during use by the domestic animal. In other embodiments, the lid 26 and the lip 18 are threaded and each cooperate with each other to prevent unintentional release of the aqueous composition outside of the container 10. In various embodiments, the lid 26 and the lip 18 cooperate to form a lock and key mechanism to prevent unintentional release of the aqueous composition outside of the container 10.

The container 10 may further include a sealing layer 28 (not shown) disposed between the shell 12 and the lid 26. In certain embodiments, the sealing layer 28 may be disposed on the shelf 34 for sealing the chamber 24 from the environment. The sealing layer 28 may be formed of a biodegradable material, such as the biodegradable material described above for the shell 12. The sealing layer 28 may be adapted to prevent contamination or tampering of the aqueous composition disposed within the container 10. In certain embodiments, the lip 18 may extend transverse and outwardly relative to the wall 16 to an outer edge 30 (not shown) for forming a surface to which the sealing layer 28 may be adhered to. The sealing layer 28 may be adhered to the lip 18 using any adhesive known in the art for preventing contamination or tampering by a sealing layer.

In an exemplary embodiment, the lid 26 is first removed from the shell 12. Next, the sealing layer 28 is removed from the shell 12. Then, the extension 40 of the lid 26 receives the base 14 of the shell 12 to stabilize the shell 12. Next, the domestic animal feeds from the chamber 24 to consume the aqueous composition. Then, the lid 26 is removed from the base 14 and coupled to the lip 18 of the shell 12 to seal any aqueous composition remaining in the chamber 24. The container 10 may be stored, for example in a bag, until the next feeding without any unintentional release of the aqueous composition outside of the container 10.

The container 10 may further included a shrink band 32 (not shown) disposed on the lid 26 and the shell 12 and adapted to couple the lid 26 to the shell 12. The shrink band 32 may be formed of a biodegradable material, such as the biodegradable material described above for the shell 12. The shrink band 32 may be adapted to prevent contamination or tampering of the aqueous composition disposed within the container 10 by preventing removal of the lid 26 from the shell 12.

As introduced above, the aqueous composition is disposed within the chamber 24. The container 10 may include the aqueous composition in the chamber 24 in an amount of from about 1 to about 100,000 mL, alternatively from about 1 to about 1000 mL, alternatively from about 50 to about 500 mL, or alternatively from about 100 to about 300 mL.

In various embodiments, the aqueous composition may include water derived from an underground formation of the earth, such a spring water. However, it is to be appreciated that the aqueous composition may include water from any source, such as distilled water.

In certain embodiments, the aqueous composition includes an active component. The active component can be used to treat nutritional deficiencies. Non-limiting examples of nutritional deficiencies can include a depressed immune system, environmental contamination, birth defects, heart disease, cancer, eye diseases, nightblindness, osteoporosis, low hormone levels, hypertension, and combinations thereof. Nutritional agents may provide a nutritional benefit. Non-limiting examples of nutritional benefits can include disease prevention, lowering cholesterol, increased energy and alertness, reducing the effects of aging, restoring digestive balance, and treating nutritional deficiency symptoms and combinations thereof. Non-limiting examples of nutritional deficiency symptoms can include fatigue, muscle weakness, irritability, fur loss, unintentional weight loss, unintentional weight gain, decreased mental ability, stress, bone fractures, decreased eyesight, decreased rate of wound healing, hyperactivity, dermatitis, cardiac arrhythmias, depression, and combinations thereof.

The active component may include a nutraceutical compound, a pharmaceutical compound, or a combination thereof. The nutraceutical compound may include a vitamin, a mineral, an electrolyte, an herbal compound, an amino acid compound, a fatty acid, an enzyme, a probiotic, cannabidiol compound, or combinations thereof. The aqueous composition may include the active component in an amount from about 0.1 g to about 1000 g, alternatively from about 1 g to about 100 g, alternatively from about 1 g to about 75 g, alternatively from about 5 g to about 50 g, per 237 mL (8 ounces) of the aqueous composition.

In various embodiments, the container 10 includes 16 ounces of the aqueous composition and may include the active component in an amount from about 1 g to about 100 g, alternatively from about 1 g to about 75 g, alternatively from about 5 g to about 15 g. In some embodiments, the container 10 includes 32 ounces of the aqueous composition and may include the active component in an amount from about 1 g to about 100 g, alternatively from about 1 g to about 75 g, alternatively from about 10 g to about 25 g. In other embodiments, the container 10 includes 64 ounces of the aqueous composition and may include the active component in an amount from about 1 g to about 100 g, alternatively from about 1 g to about 75 g, alternatively from about 20 g to about 50 g.

The vitamin may include a vitamin B, vitamin C, vitamin D, or combinations thereof. However, it is to be appreciated that the vitamin may include any other vitamin known in the art for safe consumption by a domestic animal. The aqueous composition may include the vitamin in an amount from about 0.5 mcg to about 25 mg, alternatively from about 1 mcg to about 25 mg, alternatively from about 5 mcg to about 25 mg, alternatively from about 5 mcg to about 20 mg, alternatively from about 5 mcg to about 15 mg, or alternatively from about 8 mcg to about 15 mg, per mL of the aqueous composition.

The mineral may include calcium, phosphorus, magnesium, sodium, chloride, potassium, sulfur, trace minerals, or combinations thereof. However, it is to be appreciated that the mineral may include any other mineral known in the art for safe consumption by a domestic animal. The aqueous composition may include the mineral in an amount from about 0.5 mg to about 25 mg, alternatively from about 1 mg to about 25 mg, alternatively from about 5 mg to about 25 mg, alternatively from about 5 mg to about 20 mg, alternatively from about 5 mg to about 15 mg, or alternatively from about 8 mg to about 15 mg, per mL of the aqueous composition.

The electrolyte may include sodium chloride, potassium chloride, chlorine, magnesium chloride, or combinations thereof, and any of the minerals described above, including zinc, iron, calcium, iodine, copper, magnesium, potassium, chromium, selenium, or combinations thereof. However, it is to be appreciated that the electrolyte may include any other electrolyte known in the art for safe consumption by a domestic animal. The aqueous composition may include the electrolyte in an amount from about 0.5 mg to about 25 mg, alternatively from about 1 mg to about 25 mg, alternatively from about 5 mg to about 25 mg, alternatively from about 5 mg to about 20 mg, alternatively from about 5 mg to about 15 mg, or alternatively from about 8 mg to about 15 mg, per mL of the aqueous composition.

The herbal compound may include aloe vera, calendula flowers, ginger, goldenseal, milk thistle, valerian, chamomile, California poppy, or combinations thereof. However, it is to be appreciated that the herbal compound may include any other herbal compound known in the art for safe consumption by a domestic animal. The aqueous composition may include the herbal compound in an amount from about 0.5 mg to about 25 mg, alternatively from about 1 mg to about 25 mg, alternatively from about 5 mg to about 25 mg, alternatively from about 5 mg to about 20 mg, alternatively from about 5 mg to about 15 mg, or alternatively from about 8 mg to about 15 mg, per mL of the aqueous composition.

The amino acid compound may include an amino acid, a derivative thereof, an intermediate thereof, a prodrug thereof, or combinations thereof. However, it is to be appreciated that the amino acid compound may include any other amino acid compound known in the art for safe consumption by a domestic animal. The aqueous composition may include the amino acid compound in an amount from about 0.5 mg to about 25 mg, alternatively from about 1 mg to about 25 mg, alternatively from about 5 mg to about 25 mg, alternatively from about 5 mg to about 20 mg, alternatively from about 5 mg to about 15 mg, or alternatively from about 8 mg to about 15 mg, per mL of the aqueous composition.

The fatty acid may include an omega-3 fatty acid, such as derived from fish oil. However, it is to be appreciated that the fatty acid may include any other fatty acid known in the art for safe consumption by a domestic animal. The aqueous composition may include the fatty acid in an amount from about 0.5 mg to about 25 mg, alternatively from about 1 mg to about 25 mg, alternatively from about 5 mg to about 25 mg, alternatively from about 5 mg to about 20 mg, alternatively from about 5 mg to about 15 mg, or alternatively from about 8 mg to about 15 mg, per mL of the aqueous composition.

The enzyme may include bromelain, coenzyme Q10, or a combination thereof. However, it is to be appreciated that the enzyme may include any other enzyme known in the art for safe consumption by a domestic animal. The aqueous composition may include the enzyme in an amount from about 0.5 mg to about 25 mg, alternatively from about 1 mg to about 25 mg, alternatively from about 5 mg to about 25 mg, alternatively from about 5 mg to about 20 mg, alternatively from about 5 mg to about 15 mg, or alternatively from about 8 mg to about 15 mg, per mL of the aqueous composition.

The probiotic may include Enterococcus faecium, Lactobacillus acidophilus, Lactobacillus casei, Lactobacillus plantarum, Bifidobacterium bifidum, Bifidobacterium animalis, or combinations thereof. However, it is to be appreciated that the probiotic may include any other probiotic known in the art for safe consumption by a domestic animal. The aqueous composition may include the probiotic in an amount from about 0.5 mg to about 25 mg, alternatively from about 1 mg to about 25 mg, alternatively from about 5 mg to about 25 mg, alternatively from about 5 mg to about 20 mg, alternatively from about 5 mg to about 15 mg, or alternatively from about 8 mg to about 15 mg, per mL of the aqueous composition.

The cannabidiol compound may include a cannabidiol (CBD), derivative, intermediate, or prodrug thereof. In an embodiment, the cannabidiol (CBD) may be a plant-extract, a synthetic compound, or a semi-synthetic compound. Non-limiting examples of suitable cannabidiols (CBD), cannabidiol derivatives, intermediates, or prodrugs include, cannabidiolic acid (CBDA), cannabinol (CBN), cannabigerolic acid (CBGA), cannabinoid (CBG), cannabichromenic acid (CBCA), cannabichromene (CBC), cannabidivarin acid (CBDVA), cannabidivarin (CBDV), cannabigerovarin acid (CBGVA), or combinations thereof. However, it is to be appreciated that the cannabidiol compound may include any other cannabidiol compound known in the art for safe consumption by a domestic animal. The aqueous composition may include the cannabidiol compound in an amount from about 0.5 mg to about 25 mg, alternatively from about 1 mg to about 25 mg, alternatively from about 5 mg to about 25 mg, alternatively from about 5 mg to about 20 mg, alternatively from about 5 mg to about 15 mg, or alternatively from about 8 mg to about 15 mg, per mL of the aqueous composition.

The composition may include other nutraceutical compounds including, but not limited to, 5-HTP (5-hydroxytryptophan), 7-keto-DHEA (dehydroepiandrosterone), acetate, acetyl-L-carnitine, AE-941, α-carotene, α-hydroxy acids, α-aminohydrocinnamic acid, α-ketoglutarate, α-galactosidase, α-linolenic acid, α-lipoic acid, α-tocopherol, SHA-10, androstenediol, androstenedione, arginine, aspartic acid (aspartate), ascorbic acid, β-alanine, β alanyl L histidine, β-carotene, β-cryptoxanthin, β-D-fructofuranosidase, betadine, β-glucan, β-glycans, betaine, β-sitosterol, β-tocopherol, BMS-214778, calcium carbonate matrix, calcium phosphate, caprylic acid, canthaxanthin, CDP-choline, chelated calcium, cholecalciferol, choline, chondroitin sulfate, citicoline, citric acid, creatine, cryptoxanthin, cysteine, D-calcium pantothenate, dehydroepiandrosterone, delta-tocopherol, dexpanthenol, dextran-iron, DGL (deglycyrrhiziated licorice), EA (Dehydroepiandrosterone), dibencozide, dichloroacetate, dimethylglycine, dimethylsulfone, disodium disuccinate astaxanthin, D,L-phenylalanine, DMAE (Dimethylaminoethanol), D-mannose, DMSO (dimethyl sulfoxide), docosahexaenoic acid, docusate sodium, eburnamenine-14-carboxylic acid, EDTA (ethylenediamine tetraacetic acid), EFA (essential fatty acid), ellagic acid, eicosapentaenoic acid, ferrous gluconate, ferrous sulfate, 5-hydroxytryptophan, flavonoid, folacin, folate, folic acid, forskolin, fructo-oligosaccharides, GABA (gamma-aminobutyric acid), galanthamine hydrobromide, γ-carotene, γ-linolenic acid, γ-oryzanol, γ-glutamylcysteinylglycine, γ-tocopherol, glucosamine, glucosamine sulfate, glutamine, glutamic acid, glutathione, glycerol, glycerophosphocholine, glycine, histidine, HMB (β-hydroxy-β-methylbutyrate monohydrate), hydroxocobalamin, hydroxycitric acid, hydroxymethylbutyrate, hydroxytryptophan, hyoscine butylbromide (scopolamine), hydroxylysine, hydroxyproline, hypoxanthine riboside, indole-3-carbinol, inosine, inositol hexanicotinate, inositol hexaphosphate, isoascorbic acid, isoflavones, isoleucine, lactic acid, L-arginine, L-ascorbic acid, L-asparagine, L-carnitine, L-Dopa, leucine, L-phenylalanine, L-tryptophan, luzindole, lycopene, lysine, malic acid, mesoglycan, methionine, methylcobalamin, methylguanidine acetic acid, methylsulfonylmethane, monounsaturated fatty acid, N-3 fatty acids, N-acetyl cysteine, N-acetyl D-glucosamine, N-acetyl-5-methoxytryptamine, N-acetylaspartic acid, NADH, niacin, nicotinamide adenine dinucleotide, nordihydroguaiaretic acid (NDGA), octacosanol, octanoic acid, oleuropein, omega-3 fatty acids, omega-6 fatty acids, omega-9 fatty acid, PABA (para-aminobenzoic acid), pangamic acid, pantethine, pantothenic acid, pantothenol, perillyl alcohol, PGG-glucan, phenylacetate, phosphatidylcholine, phosphatidylserine, phytoestrogen, phytonadione, phytosterols, polyphenols, polysaccharide-K, polyunsaturated fatty acids, polyvinylpyrrolidone-iodine, potassium, potassium aspartate, potassium phosphate, povidone-iodine, pregnenolone, progesterone, provitamin a, pteroylglutamic acid, pyridoxine, pyridoxal-5-phosphate, quercetin, quercetin-3-rhamnoglucoside, quercetin-3-rutinoside, quinine, resveratrol, retinol, riboflavin, riboflavin-5-phosphate, salicin, salicylate, SAM-e (S-adenosylmethionine), sitostanol, sitosterol, sitosterolins, sodium alginate, sodium ascorbate, sodium chloride, sodium ferric gluconate, sodium iodide, sodium phenylacetate, sodium phosphate, sorbic acid, stigmasterol, sulforaphane, synephrine, tannic acid, theanine, theobromine, thiamin, thioctic acid, tocopherols, tocotrienols, triacylglycerol lipase, tricholine citrate (TRI), troxerutin, tryptophan, tyrosine, acetyl-L-tyrosine, ubidecarenone, ubiquinone, urosolic acid, usnic acid, valine, vitamin A, vitamin B1, vitamin B12, vitamin B2, vitamin B3, vitamin B5, vitamin B6, vitamin B9, vitamin B complex, vitamin C, vitamin D, vitamin D2, vitamin D3, vitamin E, vitamin G, vitamin H, vitamin K, vitamin M, vitamin O, vitamin Q10, xylitol, or zeaxanthin.

Additional example of suitable nutraceutical compounds include, but not limited to, aaron's rod (verbascum thapsus), abelmoschus moschatus, Abrus precatorius, absinthe, abuta, acacia, acacia senegal, acai, acemannan, acerola, achicoria, achillea millefolium, achiote, ackee, aconite, aconitum napellus, acorns calamus L., actaea racemosa L., actinidia chinensis, actinidia deliciosa, adam's needle, adelfa, adrue, aegle marmelos, aesculus hippocastanum L., african wild potato, agathosma betulina, agave americana, agave sisalana, agrimonia eupatoria, agrimonia odorata, agrimonia procera, agrimony, agropyron repens, aguacate, alanine, albahaca morada, albaricoque, albarraz, alchemilla vulgaris, alcusa, alder, alfalfa, algarrobo, algin, alizarin, alkanet tinctoria, allium cepa, allium sativum, allium ursinum, allspice, almendra amarga, almendra dulce, aloe, aloe barbadensis, aloe ferox, aloe vera, alpine cranberry, alpinia galanga, alpinia officinarum, althaea officinalis, aluminum phosphate, amanita muscaria, amaranth, amargo, ambrette (abelmoschus moschatus), american aloe, american hellebore, american pawpaw, american pennyroyal, american scullcap, american valerian, american white water lily, american yew, aminobenzoic acid, amla fruit, ammi visnaga, amomum, Anacardium occidentale, Ananas comosus, Ananas sativus, anapsos, anchusa, andiroba, andrographis paniculata, anemone acutiloba, angelica sinensis, angel's trumpet, angostura trifoliata, anis estrellado, annatto, annona muricata, annual mugwort, annual wormwood, antelaea azadirachta, anthemis grandiflorum, anthemis nobilis, anthozoa, antineoplastones, antineoplastons, AFA (aphanizomenon flos-aquae), apis cerana, Apis mellifera, Apium graveolens, Apocynum cannabinum, apple cider vinegar, apricot, Arachis hypogaea, Arbre fricassee, arbutin, arcilla, arctium lappa, arctium majus, arctostaphylos, arctostaphylos uva-ursi, areca catechu L., arecoline, aristolochia, armeniaca vulgaris, armoracia rusticana, arnica montana, arrowroot, arsenicum album, artemisia absinthium, artemisia annua, artemisia vulgaris, arthrospira plantensis, artichoke, artocarpus heterophyllus, arundinaria japonica, asafoetida, asarabacca, asarum, asclepias tuberosa, ascophyllum nodosum, ashwagandha, asian ginseng, asimina americana, asimina triloba, asophyllum nodosum, aspalathus linearis, asparagus, asparagus officinalis, aspen, asperula odorata, aspérula olorosa, astaxanthin, astaxantina, asthma weed, astrágalo, astragalus, Astragalus membranaceus, Atropa belladonna, australian tea tree oil, autumn crocus, aveloz, avena extract, avocado, azadirachta indica, ba ji tian, babassu, baccharis genistelloides, baccharis trimera, baccharis triptera, bacopa, bacopa monnieri, bael fruit, baikal skullcap, ballota nigra, balm of gilead, balsam herb, bamboo, bantu tulip, banxia houpo tang, baptisia australis, barbados cherry, barberry, bardana, barosma betulina, bay leaf, bayberry, bear's garlic, bearberry, bedstraw, bee pollen, beeswax, beet, bejunco de cerca, belcho (ephedra sinica), belladona, bellis perennis, bentonite, berberina, berberine, berberis aristata, berberis vulgaris, bergamot oil, β-vulgaris, betel nut, betony, betula spp., bifidobacteria, bilberry, biminne, bing gan tang, birch sugar, birthwort, bishop's weed, bismuth, bitter almond, bitter aloe, bitter ash, bitter gourd, bitter melon, bitter orange, bitter wood, bitterroot, bixa orellana, biznaga, black bryony, black cohosh, black currant, black haw, black horehound, black mulberry, black mufstard oil, black pepper, black seed, black tea, blackberry, black cherry, black walnut, bladderwrack, blessed thistle, blighia sapida, bloodroot, blue cohosh, blue flag root, blue rocket (aconite), blueberry, blue-green algae, bluperum, boldo, boneset, borage seed oil, Borago officinalis, borforsin, boswelia carterii, boswellia sacra, boswellia serrata, bovine cartilage, boxwood, brahmi, brassica campestris oil, brassica nigra, Brassica oleracea, brazilian vetiver, bromelain, broom corn, brugmansia, bryonia, b-sitosterol, buchu, buckhorn plantain, buckshorn plantain, buckthorn, buckwheat, bugleweed, bulbous buttercup, bupleurum, burdock, butanediol, butcher's broom, butterbur, buxus sempervirens L., cabbage rose, cactus prickly pear, cajeput oil, calaguala, calamus, calcitriol, calendula, california jimson weed, california poppy, calophyllum inophyllum L., calostro bovino, Camellia sinensis, campesterol, camphor, canadian hemp, cancer weed, Cannabis sativa, canola oil, cantharis, capsella bursa-pastoris, capsicum, carapa ssp., caraway, caraway oil, carbohydrate supplement, cardamom, cardamomo, cardo bendito, cardo lechero, Carica papaya, carnitine, carnosine, carob, carotene, carqueja (baccharis genistelloides), carrageenan, carrot, carthamus tinctorius, cascara sagrada, cashew, castaña de indias, castor oil, castor seed, caterpillar fungus, catha edulis, catnip, cat's claw, cat's hair, catuaba, caulophyllum thalictroides, cayenne, cebada, cebolla albarrana, cedar leaf oil, celandine, cemphire, centaurea benedicta, centaurea cyanus, centella asiatica, century plant (agave americanan), cephaelis ipecacuanha, ceratonia asiatica, ceratonia siliqua, cervus elaphus, cervus nippon, cetyl myristoleate, ceylon citronella, chamaemelum nobile, chamomile, chaparral, chasteberry, chaste tree, chelidonium majus, chenopodium quina, chenopodium vulvaria, chewing tobacco, chia, chickweed, chicory, chili pepper, china rose, chinese angelica, chinese boxthorn, chinese foxglove, chinese gelatin, chinese ginger, chinese ginseng, chinese matrimony vine, chinese star anise, chinese wormwood, chintul, chirayata, chitosan, chlorella, Cholestin®, chrysanthemum, chrysanthemum vulgare, chrysin, chrysopogon spp., Cichorium intybus, cicuta virosa, cider vinegar, cimicifuga racemosa, cinnamomum aromaticum, cinnamon, cissampelos pareira, citrillus colocynthis, citronella grass, citrulline, citrus aurantifolia, citrus aurantium, citrus bergamia, citrus naringinine, citrus paradisi, citrus reticulata, Claviceps purpurea, clavo de olor, cloud mushroom, clove, club moss, cnidium monnieri, cobalamin, coca, coccinia indica, cochlearia armoracia, cockleburr, coconut oil, codonopsis, coenzyme Q10, coenzyme R, cohosh azul, cohosh negro, cola nut, colchicum, coleus forskohlii, coltsfoot, colubrina arborescens, comfrey, commifora mukul, commiphora molmol, commiphora myrrha, condurango, cone flower, conium maculatum, consuelda, copaiba balsam, copaifera officinalis, coptis formula, coral calcium, cordyceps sinensis, coriolus mushroom, coriolus versicolor, corn poppy, corn silk, corn sugar gum, cornflower, cornus spp., corydalis, corylus avellana, corynanthe yohimbi, costmary, cottonseed oil, cottonwood, couch grass, cow parsnip, cowbane, cowhage, cowslip (primula veris), crab's eye, cramp bark, cranberry, cranesbill, crataegus, cumin, creosote bush, cucurbita pepo, cupressus sempervirens, curcuma domestica, Curcuma longa, curcumin, curly dock, cusparia febrifuga, cusparia trifoliata, cuspidatum, custard apple, cyamopsis tetragonolobus, cyanocobalamin, cymbopogon spp., cynara scolymus, cyperus articulatus, cypress, cypripedium acaule, cypripedium calceolus, cystadane, cytisus scoparius, daio-kanzo-to, daisy, damiana, dandelion, dangshen (or danshen), date palm, datura meteloides, datura sauveolens, datura stramonium, datura wrightii, Daucus carota, deadly nightshade, deanol, deer velvet, desert parsley, devil's claw, devil's club, di huang, diente de leon, diet, macrobiotic, dietary fiber, dietary saccharides, digitalis, dill, dioscorea communis, dioscorea villosa L., diviner's sage, dogwood, dolichos pruriens, dolomite, dong quai, D-pantothenic acid, D-phenylalanine, dromaius novaehollandiae, drosera, dumontiaceae, dutchman's pipe, eastern hemlock, echinacea, echinacea angustifolia, Echinacea purpurea, echium, elderberry, elecampane, electro colloidal silver, elemental iron, elettaria cardamomum, Eleusine indica, elletaria cardamomum, elymus repens, emu oil, enebrina, english chamomile, english ivy, english walnut, english yew, ephedra, EGCG (Epigallocatechin gallate), epilobium angustifolium, epilobium parviflorum, epimedium grandiflorum, equinácea, equisetum arvense L., ergocalciferol, eriodictyon californicum, erythroxylum vacciniifolium, eschscholzia californica, escoba negra, espirulina, Essiac®, estevia, eucalyptus oil, euforbio, eufrasia, eugenia aromatica, eupatorium perfoliatum, euphorbia, euphorbiaceae, euphrasia officinalis, european cranberry, euterpe oleracea, evening primrose oil, evodia rutecarpa, eyebright, fagopyrum esculentum, fennel (foeniculum vulgare mill.), fenugreek, fermented milk, ferula assafoetida, feverfew, fucus carica, fucus inspida, fig, filipendula ulmaria, fireweed, flaxseed and flaxseed oil, fleet phospho-soda, fleet enema, Flor-Essence®, fly agaric, fo-ti, foxglove, fragaria, fragaria vesca, frambuesa, frangula purshiana, frankincense, fraxinus, french rose, friar's cap, fructus barbarum, fucus vesiculosus, fuzheng jiedu tang, gallic acid, galanga, galanthus, galipea officinalis, galium odoratum, gallium aparine, gambierdiscus toxicus, Ganoderma lucidum, garcinia cambogia, garcinia mangostana, garcinia, ácido hydroxicítrico, garlic, garra del diablo (harpagophytum procumbens), gelatin, gelidiella acerosa, gelsemium, genistein, gentian, gentian violet, geranium maculatum, german chamomile, germander, germanio, germanium, germanium sesquioxide, germinated barley foodstuffs, giant knotweed, gimnema, gentian, ginger, ginkgo, ginseng, glechoma hederacea, globe artichoke, glycine soja, Glycyrrhiza glabra, gobi, goji, goldenrod, goldenseal, goniopora spp., goosegrass, gossypol, gotu kola, gotu kola y fracción triterpénica total de lacentella asiática (TTFCA), you qi (chinese wolfberry), gramilla, granada, grape seed extract, grapefruit, grass pea, graviola, greater celandine, greater galangal, green hellebore, green tea, griffonia, grifola frondosa, grindelia, grindelia camporum, ground ivy, guar gum, guarana, guayule, guelder rose, guggals, guggul, gum acacia, gum arabic, gumweed, guru nut, gymnema sylvestre, gynostemma pentaphyllum, hamamelis, hange koboku-to, haritaki, harpagophytum procumbens, hashish, hawthorn, hazelnut, hedeoma pulegioides L., hedera helix, Helianthus annuus, hellebore, hemlock, hemp seed oil, hepatica, heracleum maximum, hesperidin, hibiscus, hiedra terrestre, hierba carmin, hierba de cabra en celo (epimedium grandiflorum), hierba de limon (lemon grass), hierba de san juan (hypericum perforatum L.), hierba de trigo (Triticum aestivum), high bush cranberry, hippophae rhamnoides, holy basil, hochu-ekki-to, honey, honeysuckle, hongo maitake, hoodia gordonii, Hordeum vulgare, horehound, horny goat weed, horse chestnut, horse chestnut seed extract, horse heal, horseradish, horsetail, hou po (magnolia bark), hoxsey formula, huang qi, huang-teng ken, Humulus lupulus L., huperzia serrata, huperzine A, hyaluronic acid, hydrangea arborescens, hydrastis canadensis, hydrazine sulfate, hydrocotyle asiatica, hydrilla, hypericum perforatum, hypoxis hemerocallidea, hypoxis rooperi, hyssopus officinalis, ignacia (or ignatia), illicium verum, impatiens biflora, impatiens pallida, indian bael, indian barberry, indian fig, indian licorice, indian mulberry, indian poke, indian snakeroot, indian tobacco, inula campana, inula helenium, ipecac, ipomoea orizabensis, ipriflavone, iris versicolor, isatis indigotica, iscador, isphagula, ivy, jackfruit, jamaican quassia, japanese yew, japanese sophora, jasmine, jengibre, jequirity, jervine alkaloids, jewelweed, jianpi wenshen recipe, jiaogulan, jimson weed, jointed flatsedge, jojoba, joshua tree, juglans regia, juniper, kan Jang®, karaya gum, karkada, katuka, kale, kava (piper methysticum), kefir, kelp, khat (catha edulis), khella (ammi visnaga, also known as khellin), kinetin, kiwi, kiwifruit, klamath weed, kola nut, korean red ginseng, krebiozen, krestin, hill oil, kudzu, labrador tea, lactalbumin, Lactobacillus acidophilus, Lactobacillus casei, lactobacillus GG, Lactobacillus plantarum, Lactobacillus reuteri, Lactobacillus sporogenes, lactobacilo acidófilo, lactoferrin, ladies mantle, lady's slipper, laetrile, lagerstroemia speciosa L., larch arabinogalactan, larix, larrea divaricata, larrea tridentata, lathyrus, Laurus nobilis, laurus persea, lavender, lecithin, ledum groenlandicum, ledum latifolium, ledum palustre, legume, lei gong teng, lemon balm, lemongrass, lentinan, lentinula edodes, lentinus edodes, lentisco, leonurus cardiaca, lepidium meyenii, lepidium peruvianum chacón, lesser celandine, lesser galangal, lessertia frutescens, levisticum officinale, levoglutamide, lichen, licorice, lignans, ligustrum, lime, lime flower, linden, lingonberry, linseed oil, Linum usitatissimum, lipase, lirio azul, lirio de agua blanco (nymphaea odorata), liverwort, L-norvaline, lobelia inflata, locust bean, lomatium, lomatium dissectum, long pepper, lonicera spp., lophosphora spp., lophosphora williamsii, lorenzo's oil, lotus, lousewort, lovage, lucky nut, lúpulo, lutein, luteina, Lycopersicon esculentum, lycopodium clavatum, lycopodium serrata, lycopus americanus, lycopus europaeus, lycopus lucidus, lycopus virginicus, lysichiton americanu, ma huang, maca (lepidium peruvianum chacón), macrobiotic diet, madagascar jewel, madder (rubia tinctorum), maeng lak kha, magic mint, magnolia, magnolia and pinelliae formula, mahonia, maidenhair tree, maitake mushroom, malpidnia glabra, malpighia glabra, malpighia punicifolia, malus sylvestris, maltas malvavisco, mangaresa, mandarin, mangosteen, manto de nuestra señora (alchemilla vulgaris), manzanilla, MAP30, maranta arundinacea, maria pastora, marigold, marijuana, marrubio blanco, marrubium vulgare, marsh tea, marshmallow, marshmallow root, mastic (psitacia lentiscus), matricaria recutita, mauby bark, MCP (modified citrus pectin), meadowsweet, Medicago sativa L., melaleuca alternifolia, melaleuca leucadendron, melaleuca quinquenervia, melatonin, Melissa officinalis, menaquinones, mentha pulegium L., mentha×piperita L., menthol, mexican scammony root, mezereon, microcrystalline cellulose, microcrystalline hydroxyapatite, milenrama, milk bush, milk thistle, mistletoe, modified citrus pectin, Momordica charantia L. curcurbitaceae, momordica grosvenori, monacolin K, monascus purpureus, monkshood, morinda citrifolia, morinda officinalis, moringa, morus nigra, motherwort, mountain balm, moutan, MSM (Methylsulfonylmethane), mucuna pruriens, mugwort, muira puama, mulberry, mullein, musk seed, mustard, myrcia, myrica cerifera, myrrh, narrowleaf plantain, nasturtium officinale, neem, Nelumbo nucifera, neovastat, nepeta cataria, Nerium oleander, nettle, nexrutine, nicotiana glauca, Nicotiana tabacum, nigella sativa, noni (morinda citrifolia), nopal, northern prickly ash, norvaline, nuez de betel (areca catechu L.), nutmeg, nux vomica, nymphaea odorata, oak bark, oak moss, oat beta-glucan, oat bran/straw, oat, Ocimum basilicum, ocimum sanctum L., Oenothera biennis L., okra, old man's beard, Olea europaea, oleander, olibanum, olive leaf, olive oil, olmo resbaladizo, oplopanax horridus, opuntia streptacantha, orbignya phalerata, oregano, oregon grape, Origanum vulgare, ornithine, ovoester, oxerutin, oxykrinin, ox bile extract, pacific yew, pagoda tree, palm oil, palma enana americana (serenoa repens), pamabrom, panax ginseng, Papaver rhoeas, parietaria officinalis, parsley, parsnip, parthenium argentatum, parthenolide, pasiflora, passion flower, pastinaca, pastinaca sativa, pau d'arco, paullinia cupana, pausinystalia yohimbe, PC-SPES, peanut oil, pectin, pedicularis, pedra hume caã (myrcia salicifolia), pellitory-of-the-wall, pencil tree, pennyroyal (mentha pulegium), peony, peppermint, peppermint oil, Perilla frutescens, periwinkle, Persea americana, petadolex, petasita, petasites hybridus, petty spurge, peumus boldus, peyote, phaseolamin (white kidney bean), Phaseolus vulgaris varieties, phoenix dactylifera, phoradendron leucarpum, phyllanthus, physalis somnifera, phyto-1, phytolacca americana, picraena excelsa, picrasma excelsa, picrorhiza kurroa, pill-bearing spurge, pimenta dioica, pimpinella anisum, pine bark extract, pine pollen, pinus maritima, pinus palustris, piper methysticum, piper nigrum, pistacia lentiscus, plant stanol ester, plantago coronopus, plantago isphagula, plantago lanceolata, plantago ovata, pleurisy, podophyllum hexandrum, podophyllum peltatum, poinsettia, poison ivy, poke root, pokeweed, poleo americano, policosanol, Polygonum cuspidatum, polygonum multiflorum, polypodium leucotomos extract and anapsos, pomegranate, populus, poppy, precatory bean, prickly ash, prickly pear cactus, primula officinalis, primula veris, probeta, promensil, propagermanium, propolis, prunella vulgaris, prunus africanum, prunus amygdalus, prunus amygdulus dulcis, prunus armeniaca, prunus armeniaca L., psyllium, ptychopetalum olacoides, pueraria lobata, pueraria montana var., puerarin, puerto rican cherry, pulegone, pulsatilla, pumpkin, pumpkin seed oil, punica granatum, purple viper bugloss, pycnogenol, pygeum bark, pyrus communis, pyruvate, qing hao, qinghao, qinghaosu, quack grass, quaker bonnet, quaker buttons, quaking aspen, quassia, queen anne's lace, queen of fruits (mangosteen fruts), queen of the meadow, queen's crape myrtle, quercus alba, quercus cortex, quercus marina, quick-in-the-hand (jewelweed), quimsa-kuchu, quinoa, quinsu-cucho, quitch grass, rabdosia rubescens, radium weed, radix angelica sinensis, ranunculus bulbosus, ranunculus ficaria, rapeseed oil, raspberry, rauvolfia serpentine, red algae, red clover, red palm oil, red sorrell, red stinkwood, red yeast rice, regaliz, rehmannia, rehmannia glutinosa, reina de los prados (spiraea ulmaria), reishi mushroom, rennet, rhamnus purshiana, rheum officinale, rheum palmatum, rhodiola, Rhodiola rosea, rhododendron tomentosum, rhubarb, Thus tox, ribes nigrum, rice bran oil, ricola, noble blanco, roman chamomile, romero, rooibos, rosa canina, rosary pea, rose haw, rose hip, rose laurel, roselle, rosemary, Rosmarinus officinalis L., royal jelly, rhubarb, rubus fructicosus, rubus idaeus, rubus villosus, ruibarbo, rumalon, rumex crispus, ruscus aculeatus, ruta graveolens, rutin, rye grass, sabal serrulata, sabila, saccaromyces cerevisiae, saccharomyces boulardii, saccharomyces thermophilus, safflower, sage, saiboku-to, saiko-keishi-to, Salba®, salix alba, salix spp., salvia divinorum, salvia hispanica, salvia lavandulaefolia, salvia lavandulifolia, salvia miltiorrhiza, salvia officinalis, samambaia, sambucas nigra, sandalwood, sanguinaria canadensis, sanguinarine, santalum album, sarsaparilla, sassafras, sauco berry (sambucus nigra), saw palmetto, schisandra chinensis, schizandra berry, schizandrae, schizopeta, scopolamine, scotch broom, scullcap, scutellaria baicalensis, scutellaria barbata, scutellaria lateriflora, sea buckthorn, seaweed, bladderwrack, Secale cereale, secretin, seer sage, sehydrin, sea cucumber, selagine, senna, serine, serenoa repens, sesame oil, seso vegetal, shakuyaku-kanzo-to, shallot, shark cartilage, sheng dihuang, shepherd's purse, shepherd's purse, shiitake mushroom, shikonin, sho seiryu to, sho-saiko-to, shuang huang lian, siamese ginger, silka deer, silver birch, silver protein, silymarin, Simmondsia chinensis, sisal, skunk cabbage, slippery elm, smilax spp., smokeless tobacco, snakeroot, snowball bush, soja, solidago virgaurea, sophora, Sorghum vulgare, sorrel, sour cherry, sour orange juice, soy, soy bean extract, soy bran, soy protein, soy sprouts, soybean oil, sparteine, spinach, spirogermanium, spirulina, spurge olive, squill, st. ignatius bean, st. john's bread, st. john's wort, stachys betonica, stachys officinalis, star anise, Stellaria media, sterculia urens, stevia, stickleburr, stinging nettle, stinking goosefoot, strychnos ignatii, strychnos nux-vomica, styphnolobium japonicum, substance x, sulfato de condroitina, suma (pfaffia paniculata), sunflower seed oil, sutherlandia frutescens, swamp hellebore, sweet almond, sweet annie, sweet basil, sweet cherry, sweet orange, sweet root, sweet woodruff, sweet wormwood, sweetflag, symphytum, symphytum officinale, symplocarpus foetidus, tadenan, tamanu, tamarind, tamarindus indica L., tamus communis, tanacetum parthenium, tanacetum vulgare, tangerine, tansy, taraxacum officinale, taurine, tea tree oil, tejo, terminalia, teucrium chamaedrys, Theobroma cacao, thevetia peruviana, thuja occidentalis, thunder god vine, thyme (Thymus vulgaris), tibetan goji berry, tilofora, toki-shakuyaku-san, toxicodendron radicans (eastern poison ivy), tragacanth, tree tobacco, trembling aspen, tribulus terrestris, trichilia catigua, trierucate oil, Trifolium pratense, trigonella foenum-graecum, trigonella foenum-graecum L. leguminosae, trimethylethanolamine, tripterygium wilfordii, Triticum aestivum, tsuga canadensis, TTFCA (total triterpenic fraction of centella asiatica), tuftsin, tulsi holy basil, turkey tail mushroom, turmeric, turnera aphrodisiaca, turnera diffusa, turpentine oil, tussilago farfara, tylophora, tylophora indica, Ukrain™, ulmus rubra/ulmus fulva, umbrella arum, uncaria guianensis, uncaria tomentosa, urginea maritima, Urtica dioica, usnea barbata, uva ursi, vaccinium angustifolium, vaccinium macrocarpon, vaccinium myrtillus anthocyanoside, vaccinium vitis-idaea, valerian, velvet deer antler, velvet flower, velvetleaf, veratrum viride, verbascum thapsus, verbena, vervain, vetchling, vetiver (chrysopogon zizanioides), viburnum opulus, viburnum prunifolium, vinagre de sidra de manzana, vinca minor, vinpocetine, viper's bugloss, virginia's herbal E-Tonic™, viscum album L., vitex agnus-castus, Vitis vinifera, vulvaria, wasabia japonica, water hemlock, watercress, wheatgrass, wheat bran/grass, wheat germ, wheat sprouts, whey protein, white horehound, white mallow, white oak, white pepper, white sandalwood, white tea, white water lily, wild arrach, wild carrot, wild cherry, wild ginger, wild indigo, wild marjoram, wild rosemary, wild yam, willow bark, witch hazel, withania somnifera, wintergreen, wood betony, wolfberry, wormwood, Xango®, xanthan gum, Xanthomonas campestris, xhoba, xi yang shen, xi zhang hu huang lian, xian cao, xian ling pi, xianxao, xiao qing long tang, xiao-chai-hu-tang, xu ku cao, xue zhi kang, yadake, yagona, yam, yamabushitake mushroom, yang-mei, yongona, yaqona, yarrow, yashti-madhu, yashti-madhuka, yavatikta, yege, yellow astringent, yellow bark, yellow beeswax, yellow beet, yellow broom, yellow dock, yellow ginseng, yellow horse, yellow indian paint, yellow indigo, yellow jasmine, yellow oleander, yellow poppy, yellow puccoon, yellow root, yellow sandalwood, yellow saunders, yellow starwort, yemen myrrh, yerba dulce, yerba mate, yerba santa, yew, yi zhu, yin yang huo, yinhsing, yodo, yogaraj guggul gum resin, yohimbe bark extract (pausinystalia yohimbe), yongona, yuan hu suo, yucca, yucca aloifolia, yucca angustifolia, yucca arborescens, yucca breifolia, yucca filamentosa, yucca glauca, yucca schidigera, yucca whipplei, yun zhi, zanthoxylum americanum, zapatilla de dama, Zea mays, Zemaphyte®, Zingiber officinale roscoe, or ZMA™.

In various embodiments, the aqueous composition includes an additive component. The additive components may include a flavoring agent, a coloring agent, an emulsifier, a preservative, or combinations thereof. The additive components may be included in the aqueous composition in any effective amount known in the art for addditive compounds.

Examples of suitable flavoring agents include, but are not limited to, anethole, anise oil, benzaldehyde, blackberry, blueberry, caraway, caraway oil, cardamom oil, cardamom seed, cherry juice, cherry syrup, cinnamon, cinnamon oil, an alcohol, cinnamon water, citric acid, citric acid syrup, clove oil, cocoa, coriander oil, dextrose, eriodictyon, ethyl acetate, ethyl vanillin, fennel oil, ginger, glucose, glycerin, glycyrrhiza, grape, honey, lavender oil, lemon oil, lime, mannitol, methyl salicylate, myristica oil, orange oil orange peel, orange syrup, peppermint, peppermint oil, peppermint water, phenylethyl alcohol, pineapple, raspberry juice, raspberry syrup, rosemary oil, rose oil, rose water, sarsaparilla syrup, sorbitol, spearmint, spearmint oil, strawberry, sucrose, fructose, fruit juice, thyme oil, tolu balsam, vanilla, vanillin, wild cherry syrup, and combinations thereof. The flavoring agent may be included in the aqueous composition in any effective amount known in the art for flavoring the aqueous composition.

In various embodiments, the flavoring agents may be utilized to provide the aqueous composition with a variety of flavors. Non-limiting examples, include apple, banana, blueberry, cantaloupe, cranberry, cucumber, mango, orange, peach, pear, pineapple, raspberry, strawberry, watermelon, carrot, celery, kiwi, watermelon-kiwi, apple-banana, or combinations thereof. In certain embodiments, the domestic animal has an affinity for watermelon-kiwi, apple-banana, or a combination thereof.

Examples of suitable emulsifiers include, but are not limited to, alginic acid, sodium alginate, potassium alginate, ammonium alginate, calcium alginate, propane-1,2-diol alginate, agar, carrageenan, processed eucheuma seaweed, locust bean gum, guar gum, tragacanth, acacia gum, xanthan gum, karaya gum, tara gum, konjac, pectins, cellulose derivatives selected from: methyl cellulose, hydroxypropyl cellulose, hydroxypropyl methyl cellulose, ethyl methyl cellulose, carboxy methyl cellulose, sodium carboxy methyl cellulose, crosslinked sodium carboxy methyl cellulose, enzymatically hydrolysed carboxy methyl cellulose, gelatine, and combinations thereof. The emulsifier may be included in the aqueous composition in any effective amount known in the art for solubilizing compounds.

As introduced above, a method for forming the container is also provided herein. The method includes providing the shell 12 and the lid 26. The method further includes disposing the aqueous composition in the chamber 24 of the shell 12. The method may further include disposing the sealing layer 28 over the chamber and coupling the sealing layer to the lip 18. The method further includes coupling the lid 26 to the shell 12 to form the container 10. The method may further include disposing the shrink band on the lid 26 and the shell 12 to couple the lid 26 to the shell 12.

As also introduced above, a method of utilizing the container 10 is provided herein. The method includes providing the container 10. The method may further include removing the shrink band from at least one of the lid 26 and the shell 12. The method may further include removing the lid 26 from the shell 12. The method may further include removing the sealing layer 28 from the shell 12. The method may further include locating the shell 12 proximate the domestic animal.

A method of providing an aqueous composition to a domestic animal is also provided herein. The method includes providing the container 10. The method further includes separating the lid 26 and the shell 12 from each other. The method further includes disposing the base 14 within the extension 40 of lid 26. The method further includes feeding the aqueous composition to the domestic animal. The method further includes coupling the lid 26 and the lip of the shell 12 to store the aqueous composition.

A method for treating, ameliorating, or preventing nutritional deficiency or malnutrition in a domestic animal is also provided herein. The method includes providing a domestic animal that is malnourished. The method further includes providing the container 10. The method further includes separating the lid 26 and the shell 12 from each other. The method further includes disposing the base 14 within the extension 40 of lid 26. The method further includes feeding the aqueous composition to the domestic animal. The method further includes coupling the lid 26 and the lip of the shell 12 to store the aqueous composition.

The aqueous composition for use in a method of treating, ameliorating, or preventing nutritional deficiency or malnutrition in a domestic animal is also provided. The method includes providing a domestic animal that is nutritionally deficient. The method further includes providing the container 10. The method further includes separating the lid 26 and the shell 12 from each other. The method further includes disposing the base 14 within the extension 40 of lid 26. The method further includes feeding the aqueous composition to the domestic animal. The method further includes coupling the lid 26 and the lip of the shell 12 to store the aqueous composition. Further, as introduced above, a use of the container 10 is provided herein. The container 10 may be used for providing the aqueous composition to a domestic animal for consumption. In certain embodiments, the container 10 may be used for providing the aqueous composition to a dog for consumption. In other embodiments, the container 10 may be used for providing the aqueous composition to a cat for consumption. In various embodiments, the container 10 may be used for providing the aqueous composition to livestock for consumption.

Although the invention has been described in connection with specific preferred embodiments, it should be understood that the invention as claimed should not be unduly limited to these specific embodiments. While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

### INDUSTRIAL APPLICABILITY

While the present invention is not limited to a particular end application, use or industry, domestic animals often rely on humans to provide aqueous compositions for consumption. The container is biodegradable and may be discarded after consumption of the aqueous composition disposed therein. The container may also be useful for transporting the aqueous composition while preventing unintentional release of the aqueous composition outside of the container.

The following examples, illustrating the compositions, methods, and uses, of this disclosure, are intended to illustrate and not to limit the invention.

### EXAMPLES

The following examples are included to demonstrate various embodiments as contemplated herein. It should be appreciated by those of skill in the art that the techniques disclosed in the examples which follow represent techniques discovered by the inventor(s) to function well in the practice of the invention, and thus can be considered to constitute desirable modes for its practice. However, those of skill in the art should, in light of the present disclosure, appreciate that many changes can be made in the specific embodiments which are disclosed and still obtain a like or similar result without departing from the spirit and scope of the invention. All percentages are in wt. % and all measurements are conducted at 23° C. unless indicated otherwise.

### Example 1—Prophetic Aqueous Compositions

Exemplary prophetic aqueous compositions (“Comp.”) as contemplated herein are provided in Table 1 below. Non-limiting examples of the ingredients are described herein.

TABLE 1

| | Comp. | Comp. | Comp. | Comp. | Comp. | Comp. | Comp. | Comp. | Comp. | Comp. |
|---|---|---|---|---|---|---|---|---|---|---|
| | 1 | 2 | 3 | 4 | 5 | 6 | 7 | 8 | 9 | 10 |
| Ingredients | (wt. %) | (wt. %) | (wt. %) | (wt. %) | (wt. %) | (wt. %) | (wt. %) | (wt. %) | (wt. %) | (wt. %) |
| Vitamin | — | 1 to 50 | — | — | — | — | — | — | | 1 to 50 |
| Mineral | — | — | 1 to 50 | — | — | — | — | — | — | 1 to 50 |
| Herbal | — | — | — | 1 to 50 | — | — | — | — | — | 1 to 50 |
| compound | | | | | | | | | | |
| Amino acid | — | — | — | — | 1 to 50 | — | — | — | — | 1 to 50 |
| compound | | | | | | | | | | |
| Fatty acid | — | — | — | — | — | 1 to 50 | — | — | — | 1 to 50 |
| Enzyme | — | — | — | — | — | — | 1 to 50 | — | — | 1 to 50 |
| Probiotic | — | — | — | — | — | — | — | 1 to 50 | — | 1 to 50 |
| Cannabidiol | — | — | — | — | — | — | — | — | 1 to 50 | 1 to 50 |
| compound | | | | | | | | | | |
| Water | 100 | Bal. | Bal. | Bal. | Bal. | Bal. | Bal. | Bal. | Bal. | Bal. |
| TOTAL | 100 | 100 | 100 | 100 | 100 | 100 | 100 | 100 | 100 | 100 |

### Example 2—Exemplary Aqueous Compositions

Exemplary aqueous compositions (“Comp.”) as contemplated herein are provided in Table 2 below. Non-limiting examples of the ingredients are described herein.

TABLE 2

| | Comp. | Comp. | Comp. | Comp. | Comp. | Comp. |
|---|---|---|---|---|---|---|
| | 11 | 12 | 13 | 14 | 15 | 16 |
| Ingredients | (wt. %) | (wt. %) | (wt. %) | (wt. %) | (wt. %) | (wt. %) |
| Vitamin A | 1 to 50 | — | — | — | — | 1 to 50 |
| Vitamin D | 1 to 50 | — | — | — | — | 1 to 50 |
| Vitamin E | 1 to 50 | — | — | — | — | 1 to 50 |
| Thiamine | — | 1 to 50 | — | — | — | 1 to 50 |
| Riboflavin | — | 1 to 50 | — | — | — | 1 to 50 |
| Pantothenic | — | 1 to 50 | — | — | — | 1 to 50 |
| acid | | | | | | |
| Niacin | — | 1 to 50 | — | — | — | 1 to 50 |
| Pyridoxine | — | 1 to 50 | — | — | — | 1 to 50 |
| Folic acid | — | 1 to 50 | — | — | — | 1 to 50 |
| Vitamin B12 | — | 1 to 50 | — | — | — | 1 to 50 |
| Trace minerals | — | — | 1 to 50 | — | — | 1 to 50 |
| Electrolytes | — | — | — | 1 to 50 | — | 1 to 50 |
| Macrominerals | — | — | — | — | 1 to 50 | 1 to 50 |
| Water | 100 | Bal. | Bal. | Bal. | Bal. | Bal. |
| TOTAL | 100 | 100 | 100 | 100 | 100 | 100 |

Trace minerals include ferrous sulfate, copper sulfate, manganese sulfate, zinc sulfate, ethylenediamine dihydroiodide, and selenium, which are commercially available.

Electrolytes include sodium chloride, potassium chloride, chlorine, and magnesium chloride, which are commercially available.

Macrominerals include calcium and phosphorus, which are commercially available.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. A container for storing an aqueous composition for a domestic animal, comprising:
a shell having base and a wall extending distally from the base to a lip, the shell defining a chamber between the base and the lip;
a lid having a surface and configured to cooperate with the lip for removably coupling the lid and the shell, the lid comprising an extension extending laterally relative to the surface; and
an aqueous composition disposed within the chamber and comprising an active component;
wherein the extension is configured to receive the base for stabilizing the shell during use by the domestic animal; and
wherein the shell and the lid exhibit a water vapor transmission rate of less than 100,000 g/m²/24 hours in accordance with ASTM D6701-16.

2. The container of claim 1, wherein the shell and the lid comprise a biodegradable material comprising a polymeric material, a lignocellulosic material, or a combination thereof.

3. The container of claim 2, wherein the active component comprises a nutraceutical compound, a pharmaceutical compound, or a combination thereof.

4. The container of claim 3, wherein the nutraceutical compound comprises a vitamin, a mineral, an herbal compound, an amino acid compound, a fatty acid, an enzyme, a probiotic, cannabidiol compound, or combinations thereof.

5. The container of claim 4, wherein the vitamin comprises a vitamin B, vitamin C, vitamin D, or combinations thereof.

6. The container of claim 4, wherein the mineral comprises calcium, phosphorus, magnesium, sodium, chloride, potassium, sulfur, trace minerals, or combinations thereof.

7. The container of claim 4, wherein the herbal compound comprises aloe vera, calendula flowers, ginger, goldenseal, milk thistle, valerian, chamomile, California poppy, or combinations thereof.

8. The container of claim 4, wherein the amino acid compound comprises an amino acid, a derivative thereof, an intermediate thereof, a prodrug thereof, or combinations thereof.

9. The container of claim 4, wherein the fatty acid comprises an omega-3 fatty acid.

10. The container of claim 4, wherein the enzyme comprises bromelain, coenzyme Q10, or a combination thereof.

11. The container of claim 4, wherein the probiotic comprises Enterococcus faecium, Lactobacillus acidophilus, Lactobacillus casei, Lactobacillus plantarum, Bifidobacterium bifidum, Bifidobacterium animalis, or combinations thereof.

12. The container of claim 1, wherein the active component comprises vitamins, trace minerals, and electrolytes.

13. The container of claim 1, wherein the aqueous composition comprises an additive component and wherein the additive components comprises a flavoring agent, a coloring agent, an emulsifier, a preservative, or combinations thereof.

14. The container of claim 1, wherein the aqueous composition comprises water derived from an underground formation of the earth.

15. The container of claim 2, wherein the polymeric material is formed from polylactic acid.

16. The container of claim 2, wherein the lignocellulosic material is formed from wheat straw, bamboo, husks, sugar cane, bulrush, or combinations thereof.

17. The container of claim 1 further comprising a sealing layer disposed between the shell and the lid.

18. A method of providing an aqueous composition to a domestic animal, the method comprising:
providing a container according to claim 1, the container comprising the aqueous composition;
separating the lid and the shell from each other;
disposing the base within the extension of lid;
feeding the aqueous composition to the domestic animal; and
coupling the lid and the lip of the shell to store the aqueous composition.

19. A method for treating, ameliorating, or preventing nutritional deficiency in a domestic animal, the method comprising:
providing a domestic animal that is nutritionally deficient;
providing a container according to claim 1, the container comprising the aqueous composition;
separating the lid and the shell from each other;
disposing the base within the extension of lid;
feeding the aqueous composition to the domestic animal; and
coupling the lid and the lip of the shell to store the aqueous composition.

20. An aqueous composition for use in a method of treating, ameliorating, or preventing nutritional deficiency in a domestic animal, the method comprising:
providing a domestic animal that is nutritionally deficient;
providing a container according to claim 1, the container comprising the aqueous composition;
separating the lid and the shell from each other;
disposing the base within the extension of lid;
feeding the aqueous composition to the domestic animal; and
coupling the lid and the lip of the shell to store the aqueous composition.
